(19) United States
(12) Patent Application Publication
(10) Pub. No.: US 2014/0119029 A1
(43) Pub. Date: May 1, 2014

(54) ILLUMINATION APPARATUS

(71) Applicant: Lextar Electronics Corporation, Hsinchu (TW)

(72) Inventor: Cheng-Chieh HSIEH, Hukou Township (TW)

(73) Assignee: Lextar Electronics Corporation, Hsinchu (TW)

(21) Appl. No.: 14/015,632

(22) Filed: Aug. 30, 2013

(30) Foreign Application Priority Data
Oct. 31, 2012 (TW) 101140362

(51) Int. Cl. F21V 13/04

(52) U.S. Cl. CPC F21V 13/04
USPC 362/309; 362/308

(57) ABSTRACT

An illumination apparatus includes a substrate, a reflective cup, an illumination unit and a lens structure. The reflective cup is placed on the substrate, and includes a plurality of first fasteners. The first fasteners are placed on the outer surface of the reflective cup. The illumination unit is mounted on the substrate within the reflective cup. The lens structure covers the reflective cup, and includes a plurality of second fasteners. The second fasteners can be removably engaged with the first fasteners, so that the lens structure can be fastened on the reflective cup.

### RELATED APPLICATIONS

This application claims priority to Taiwan Application Serial Number 101140362, filed Oct. 31, 2012, which is herein incorporated by reference.

### BACKGROUND

1. Technical Field

Embodiments of the present invention relate to an illumination apparatus. More particularly, embodiments of the present invention relate to an illumination apparatus with a lens structure.

2. Description of Related Art

In recent years, eco-friendly products have been the main stream in the market. Therefore, the light emitting diode (LED) having advantages such as low power consumption, gradually replaces the incandescent light bulb and the fluorescent lamp in the illumination application and the backlight module.

Either in the illumination application or the backlight module, the emission angle of the LED is almost constant, and therefore, a secondary optical lens is used to cover the LED for modifying the illumination distribution of the LED. The typical secondary optical lens is fastened on a substrate or a lamp base with the adhesive glue. In other words, if the user would like to obtain different illumination distributions, the whole lamp has to be replaced, which raises the cost and burden in maintenance.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with one embodiment of the present invention, an illumination apparatus includes a substrate, a reflective cup, an illumination unit and a lens structure. The reflective cup is disposed on the substrate, and includes a plurality of first fasteners disposed on an outer surface thereof. The illumination unit is disposed on the substrate within the reflective cup. The lens structure covers the reflective cup, and includes a plurality of second fasteners. The second fasteners are removably engaged with the first fasteners, so that the lens structure can be fastened on the reflective cup.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an explosive view of an illumination apparatus in accordance with one embodiment of the present invention;

FIG. 2 is a side view of the assembled illumination apparatus in FIG. 1;

FIG. 3 is a top view of a reflective cup in FIG. 1;

FIG. 4 is a top view of a lens structure in FIG. 1;

FIG. 5 is an explosive view of the illumination apparatus in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

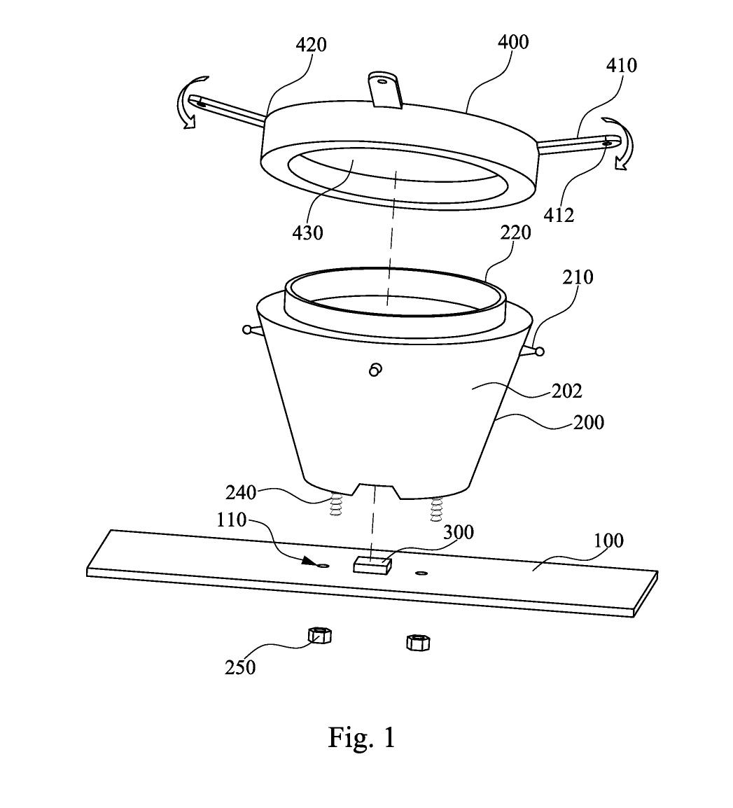

FIG. 1 is an explosive view of an illumination apparatus in accordance with one embodiment of the present invention. As shown in FIG. 1, the illumination apparatus includes a substrate 100, a reflective cup 200, an illumination unit 300 and a lens structure 400. The reflective cup 200 is disposed on the substrate 100, and includes a plurality of first fasteners 210. The first fasteners 210 are disposed on an outer surface 202 of the reflective cup 200. The illumination unit 300 is disposed on the substrate 100 within the reflective cup 200. In particular, portion of the substrate 100 is exposed in the bottom of the reflective cup 200, and the illumination unit 300 is disposed on the substrate 100. The lens structure 400 covers the reflective cup 200, and includes a plurality of second fasteners 410. The second fasteners 410 are removably engaged with the first fasteners 210, so that the lens structure 400 can be fastened on the reflective cup 200.

In the foregoing embodiment, because the second fasteners 410 are removably engaged with the first fasteners 210, the user can pull the second fasteners 410 outwardly to disengage from the first fasteners 210, and then, the lens structure 400 can be easily removed. In contrary, when the user would like to fasten the lens structure 400 on the reflective cup 200, it can be implemented by engaging the second fasteners 410 on the first fasteners 210. Therefore, the lens structure 400 in the foregoing embodiment can be easily installed and removed, and the cost to replace the whole illumination apparatus can be saved.

In some embodiments, a plurality of pivotal connection parts 420 respectively pivotally connect the second fasteners 410 to a circumference of the lens structure 400. Therefore, the second fasteners 410 can be pivotally rotated relative to the lens structure 400 (referring to the arrows aside to the second fasteners 410 in FIG. 1), so as to engage with the first fasteners 210 on the reflective cup 200. In contrary, the second fasteners 410 engaged with the first fasteners 210 can be pulled outwardly to disengage from the first fasteners 210, so that the lens structure 400 can be removed from the reflective cup 200. In some embodiments, the pivotal connection parts 420 are formed by flexible material, so as to facilitate the second fasteners 410 to pivotally rotate.

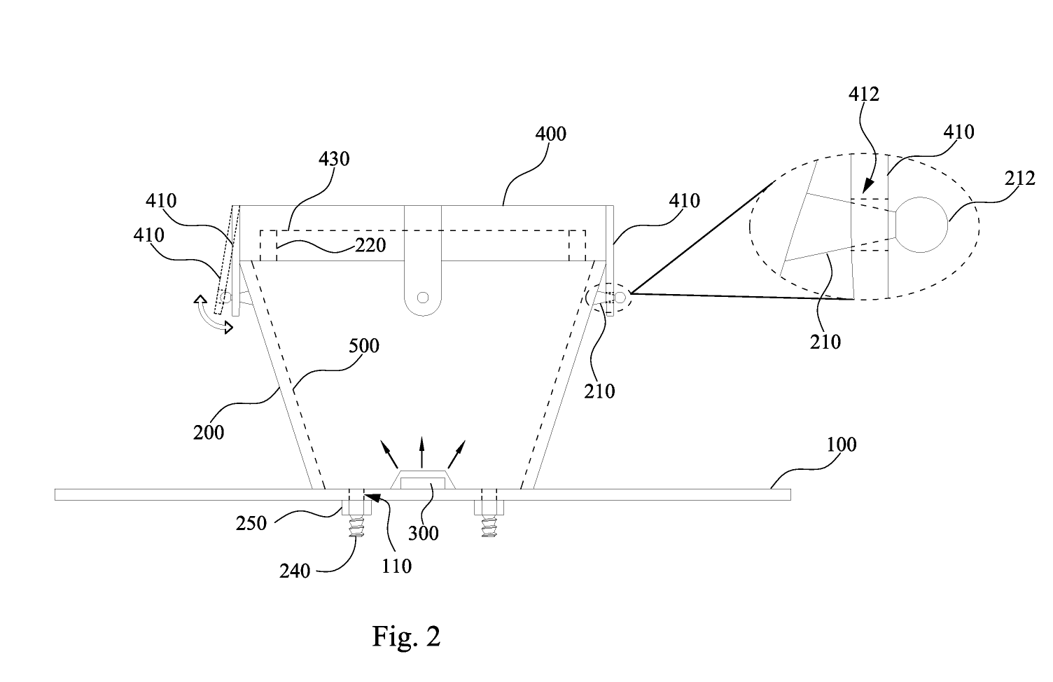

FIG. 2 is a side view of the assembled illumination apparatus in FIG. 1. As shown in FIG. 2, each of the second fasteners 410 includes a hole 412. Each of the first fasteners 210 includes an elastic protrusion 212. The elastic protrusion 212 threads through the hole 412, and presses against the second fastener 410. In particular, the size of the elastic protrusion 212 is slightly greater than the size of the hole 412, so as to facilitate the elastic protrusion 212 to press against the second fastener 410 after threading through the hole 412, thereby preventing the second fastener 410 from moving relative to the first fastener 210. In some embodiments, the elastic protrusion 212 is a sphere, and the hole 412 is a circular hole. The diameter of the hole 412 is slightly less than the diameter of the elastic protrusion 212. The shape of the elastic protrusion 212 and the shape of the hole 412 are only taken as an example, and are not used to limit the scope of the present invention. In practice, the shape of elastic protrusion 212 can also be, but is not limited to be, a cylinder, a cuboid, or a cone. The hole 412 can be, but is not limited to be, a hole with the shape corresponding to the elastic protrusion 212.

In some embodiments, the elastic protrusion 212 can be formed by elastic material. Therefore, when engaging the second fasteners 410 with the first protrusions 210, the user can press the second fasteners 410, and the second fasteners 410 can press the first fasteners 210 inwardly, and therefore, the elastic protrusions 212 will slightly shrink because the inner walls of the holes 412 presses the elastic protrusions 212. Then, the elastic protrusions 212 will thread through the holes 412. After threading through the holes 412, the elastic protrusions 212 can recover to the original shape and size, and press against the second fasteners 410.

In contrary, when disengaging the second fasteners 410 from the first fasteners 210, the user can pull the second fasteners 410 outwardly, and the elastic protrusions 212 will slightly shrink due to the pressing force from the inner walls of the holes 412, so as to go into and thread through the holes 412, thereby disengaging the second fasteners 410 from the first fasteners 210. Therefore, as long as the second fasteners 410 are pressed or pulled, the lens structure 400 can be installed or removed, which is pretty convenient for the user.

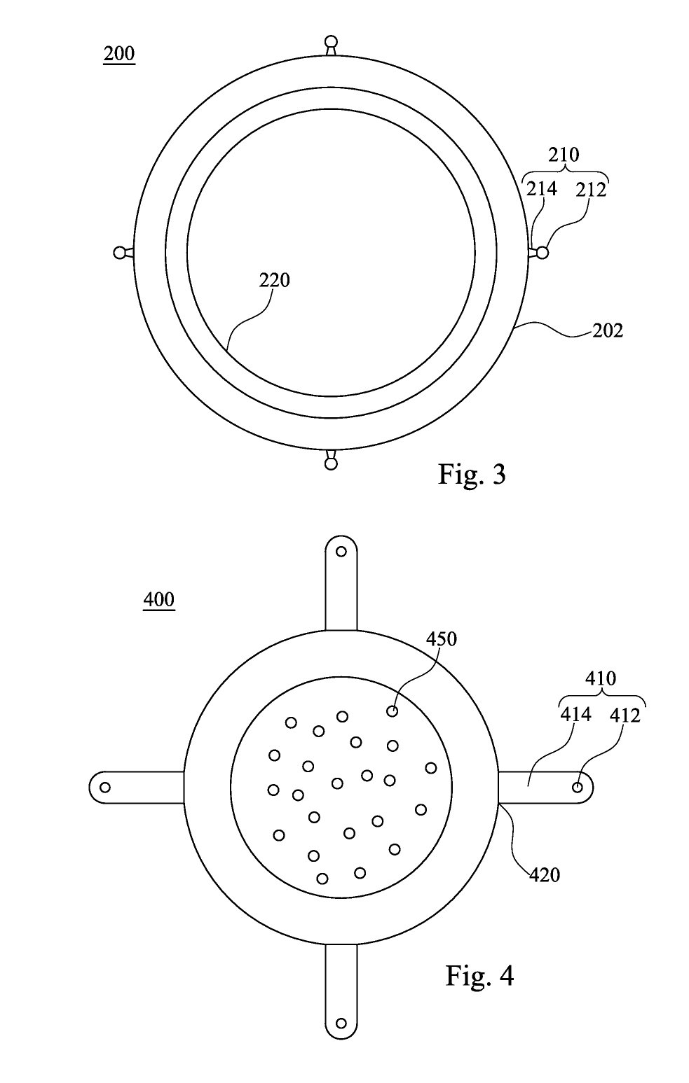

FIG. 3 is a top view of the reflective cup 200 in FIG. 1. FIG. 4 is a top view of the lens structure 400 in FIG. 1. As shown in FIGS. 3 and 4, in this embodiment, at least two of the first fasteners 210 are symmetrical to each other, and at least two of the second fasteners 410 are symmetrical to each other corresponding to the first fasteners 210. In particular, at least two of the first fasteners 210 are diametrically opposite to each other. In other words, the distance between these two first fasteners 210 is approximately equal to the outer diameter of the top surface of the reflective cup 200. Similarly, at least two of the second fasteners 410 are also diametrically opposite to each other. In other words, the distance between these two second fasteners 410 is approximately equal to the outer diameter of the lens structure 400.

In other embodiments, some or all of the first fasteners 210 can be asymmetrical to each other, and some or all of the second fasteners 410 can also be asymmetrical to each other corresponding to the first fasteners 210.

As shown in FIG. 3, the first fastener 210 may alternatively include a connection pillar 214 connected between the outer surface 202 of the reflective cup 200 and the elastic protrusion 212. The elastic protrusion 212 is protruded at an end of the connection pillar 214, and therefore, the cross-sectional area of the connection pillar 214 is less than the cross-sectional area of the elastic protrusion 212, so that the connection pillar 214 can be accommodated in the hole 412 (FIG. 2) and the elastic protrusion 212 can press against the second fastener 410 (FIG. 2) after threading through the hole 412.

As shown in FIG. 4, the second fastener 410 may alternatively include a rotatable plate 414 connected to the pivotal connection part 420, so that the second fastener 410 can take the pivotal connection part 420 as a central axis to rotate. The hole 412 is formed on the rotatable plate 414. When the first fastener 210 (FIG. 3) is engaged with the second fastener 410, the elastic protrusion 212 (FIG. 3) threads through the hole 412 and presses against the rotatable plate 414. The length of the rotatable plate 414 is greater than the thickness of the lens structure 400, which facilitates the hole 412 to be fitted onto the elastic protrusion 212 after the rotatable plate 414 rotates downwardly, so that the elastic protrusion 212 can thread through the hole 412 and press against the rotatable plate 414.

As shown in FIG. 4, in some embodiments, the lens structure 400 includes a plurality of microstructures 450 distributed on the lens structure 400 for diffusing the light emitted by the illumination unit 300.

Referring to FIGS. 1 and 2, in some embodiments the top of the reflective cup 200 includes a first connection part 220. A bottom of the lens structure 400 includes a second connection part 430. The first connection part 220 connects to the second connection part 430, so that the lens structure 400 can be fastened on the top surface of the reflective cup 200.

In particular, the first connection part 220 is an enclosed protrusion structure, and the second connection part 430 is a concave structure. The enclosed protrusion structure is accommodated in the concave structure. In other words, the first connection part 220 and the second connection part 430 are respectively a protrusion structure and a concave structure in which the shapes thereof are complementary to each other. The first connection part 220 can be accommodated in the second connection part 430, and thereby abuts against the inner wall of the second connection part 430, so as to prevent the lens structure 400 from moving relative to the reflective cup 200.

In some embodiments, a bottom of the reflective cup 200 includes a plurality of first fixing parts 240, and the substrate 100 includes a plurality of second fixing parts 110 around the illumination unit 300. The first fixing parts 240 are respectively fastened to the second fixing parts 110, so that the reflective cup 200 can be fastened on the substrate 100.

In particular, the first fixing parts 240 are screws, and the second fixing parts 110 are holes. The screws are respectively screwed in the holes. The diameter of the first fixing part 240 (the screw as shown in FIG. 1) is approximately equal to the diameter of the second fixing part 110 (the hole as shown in FIG. 1), so as to facilitate the first fixing part 240 to be tightly fitted in the second fixing part 110, thereby fastening the reflective cup 200 on the substrate 100.

In some embodiments, the first fixing parts 240 (the screws as shown in FIG. 1) thread through the substrate 100 and are exposed out of the substrate 100, and these first fixing parts 240 can be fastened by a plurality of screw nuts 250. In particular, the screw nuts 250 are respectively screwed on exposed portions of the first fixing parts 240 (the screws as shown in FIG. 1), so as to fasten the reflective cup 200 on the substrate 100.

In particular, the length of the first fixing part 240 (the screw as shown in FIG. 1) is greater than the length of the second fixing part 110 (the hole as shown in FIG. 1), so that the first fixing part 240 can thread through the second fixing part 110, and can be partially exposed out of the substrate 100. The screw nut 250 can be screwed on the first fixing part 240 exposed beneath the substrate 100, and can press against the bottom surface of the substrate 100, so as to fasten the reflective cup 200.

As shown in FIG. 2, in some embodiments, the inner surface of the reflective cup 200 is coated by a reflective material 500. For example, the reflective material 500 can be, but is not limited to be, a light color material, such as the white coating, the yellow coating or the silver coating.

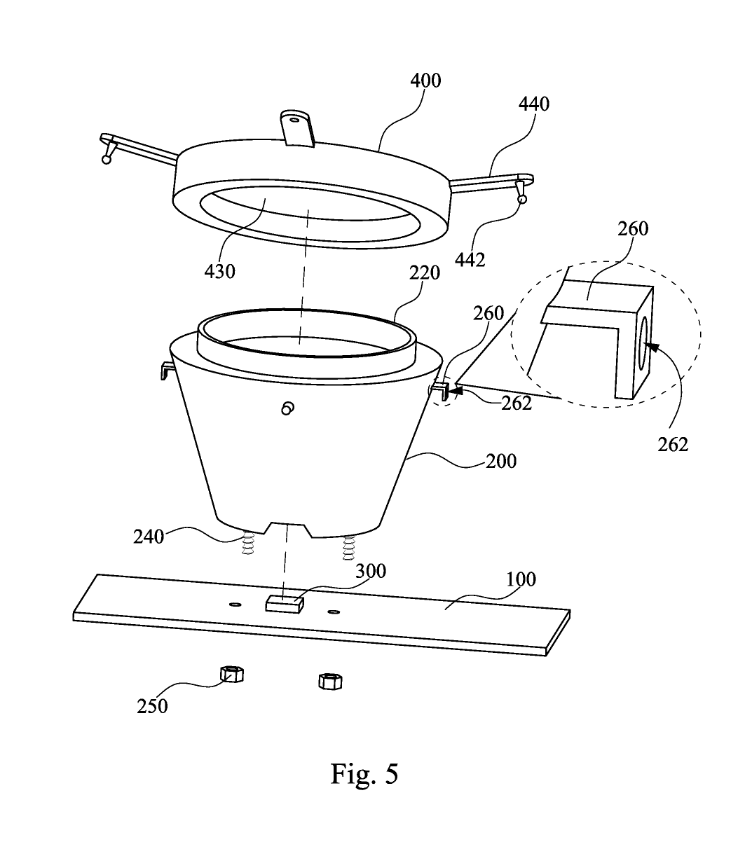

FIG. 5 is an explosive view of the illumination apparatus in accordance with another embodiment of the present invention. The main difference between this embodiment and FIG. 1 is that: the shape of the first fastener 260 is different from the shape of the first fastener 210 in FIG. 1, and the shape of the second fastener 440 is also different from the second fastener 410 in FIG. 1. In particular, in this embodiment, the first fastener 260 includes a hole 262, and the second fastener 440 includes an elastic protrusion 442. The elastic protrusion 442 threads through the hole 262 and presses against the first fastener 260.

In other words, the engaging manner in this embodiment is contrary to the engaging manner as shown in FIG. 1. After the second fastener 440 is rotated downwardly, the elastic protrusion 442 can thread through the hole 262 of the first fastener 260, thereby fastening the lens structure 400 on the reflective cup 200. In some embodiments, the elastic protrusion 442 is a sphere, and the hole 262 is a circular hole. The diameter of the hole 262 is slightly less than the diameter of the elastic protrusion 442. The shape of the elastic protrusion 442 and the shape of the hole 262 are only taken as an example, and are not used to limit the scope of the present invention. In practice, the shape of elastic protrusion 442 can also be, but is not limited to be, a cylinder, a cuboid, or a cone. The hole 262 can be, but is not limited to be, a hole with the shape corresponding to the elastic protrusion 442.

In some embodiments, the illumination unit 300 can be an LED. For example, the illumination unit 300 can be, but is not limited to be, a LED package or a LED chip. In some embodiments, the illumination unit 300 can be, but is not limited to be, a white LED, a red LED, a green LED or a blue LED.

It will be understood that when an element is referred to as being “on” another element, it can be directly on the other element or intervening elements may be present therebetween. For example, the description “the illumination unit 300 is disposed in the substrate 100” not only includes the embodiment in which the illumination unit 300 is in direct contact with the substrate 100, but also includes the embodiment in which intervening elements, such as the thermal conductive glue or thermal conductive member, are sandwiched between the illumination unit 300 and the substrate 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An illumination apparatus, comprising:
a substrate;
a reflective cup disposed on the substrate, the reflective cup comprising a plurality of first fasteners disposed on an outer surface of the reflective cup;
an illumination unit disposed on the substrate within the reflective cup; and
a lens structure covering the reflective cup, the lens structure comprising a plurality of second fasteners, wherein the second fasteners are removably engaged with the first fasteners, so that the lens structure is fastened on the reflective cup.

2. The illumination apparatus of claim 1, further comprising a plurality of pivotal connection parts respectively pivotally connecting the second fasteners to a circumference of the lens structure.

3. The illumination apparatus of claim 2, wherein each of the second fasteners comprises a hole, and each of the first fasteners comprises an elastic protrusion, wherein the elastic protrusion threads through the hole and presses against the second fastener.

4. The illumination apparatus of claim 3, wherein the elastic protrusion is a sphere, and the hole is a circular hole.

5. The illumination apparatus of claim 2, wherein each of the first fasteners comprises a hole, and each of the second fasteners comprises an elastic protrusion, wherein the elastic protrusions thread through the holes and press against the first fasteners.

6. The illumination apparatus of claim 5, wherein the elastic protrusion is a sphere, and the hole is a circular hole.

7. The illumination apparatus of claim 1, wherein the first fasteners are symmetrical or asymmetrical to each other, and the second fasteners are symmetrical or asymmetrical to each other corresponding to the first fasteners.

8. The illumination apparatus of claim 7, wherein at least two of the first fasteners are symmetrical to each other, and at least two of the second fasteners are symmetrical to each other corresponding to the first fasteners.

9. The illumination apparatus of claim 1, wherein a top of the reflective cup comprises a first connection part, and a bottom of the lens structure comprises a second connection part, wherein the first connection part connects to the second connection part, so that the lens structure is fastened on the reflective cup.

10. The illumination apparatus of claim 9, wherein the first connection part is an enclosed protrusion structure, and the second connection part is a concave structure, wherein the enclosed protrusion structure is accommodated in the concave structure.

11. The illumination apparatus of claim 1, wherein the lens structure comprises a plurality of microstructures distributed on the lens structure.

12. The illumination apparatus of claim 1, wherein a bottom of the reflective cup comprises a plurality of first fixing parts, and the substrate comprises a plurality of second fixing parts around the illumination unit, wherein the first fixing parts are respectively fastened to the second fixing parts, so that the reflective cup is fastened on the substrate.

13. The illumination apparatus of claim 12, wherein the first fixing parts are screws, and the second fixing parts are holes, wherein the screws are respectively screwed in the holes.

14. The illumination apparatus of claim 13, further comprising a plurality of screw nuts, wherein the screws thread through the substrate and are exposed out of the substrate, wherein the screw nuts are respectively screwed on exposed portions of the screws.

15. The illumination apparatus of claim 1, wherein an inner surface of the reflective cup is coated by a reflective material.
